(19) United States
(12) Patent Application Publication
(10) Pub. No.: US 2015/0300281 A1
(43) Pub. Date: Oct. 22, 2015

(54) Intake Pressure Control Strategy In Gaseous Fuel Internal Combustion Engine

(71) Applicant: Caterpillar Inc., Peoria, IL (US)

(72) Inventors: Arvind Sivasubramanian, Peoria, IL (US); Shivangi Wagle, Sterling Heights, MI (US); Christopher Gallmeyer, Chillicothe, IL (US)

(73) Assignee: Caterpillar Inc., Peoria, IL (US)

(21) Appl. No.: 14/257,093

(22) Filed: Apr. 21, 2014

(51) Int. Cl. F02D 41/00

(52) U.S. Cl. CPC F02D 41/0027

(57) ABSTRACT

Controlling intake pressure in a gaseous fuel internal combustion engine includes calculating a control term in an intake pressure control loop based on a pressure error, and adjusting a throttle valve and a second valve responsive to the control term in first and second control loop cycles. The second valve is within a return conduit returning compressed gases from a location downstream a compressor to a location upstream. A pressure of gaseous fuel and air within the intake conduit is changed via the adjustments so as to reduce the pressure error.

### TECHNICAL FIELD

The present disclosure relates generally to controlling intake pressure in a gaseous fuel engine, and relates more particularly to controlling intake pressure via positioning a throttle valve and a recirculation valve responsive to a common control term.

### BACKGROUND

Internal combustion engines are well known and widely used for propelling vehicles, generating electrical power, and driving a great many types of machinery such as pumps, compressors and industrial equipment. In certain internal combustion engines, especially those used in heavier duty applications, a turbocharger is employed to recover energy from exhaust gases and compress intake air supplied to the engine for combustion. Pressurizing the intake air generally enables the engine to extract a greater quantity of the potential energy contained in a given amount of fuel combusted with the pressurized intake air than would otherwise occur, according to well known principles. In many strategies, power output and speed of the engine depends upon an amount of fuel or charge amount delivered to the cylinders in each engine cycle. More than enough air to support successful combustion of a range of fueling amounts is commonly available, but in other instances such as lean burn engine operation the engine can be sensitive to both the fueling amount and a ratio of fuel to air. Increased or decreased intake air pressure can affect the air to fuel ratio, and can occur from varying turbocharger speed. Too much air pressure, and the engine can experience ignition problems. Too little, and combustion of the relatively richer mixture of fuel and air can compromise emissions.

For these and other reasons, various strategies have been proposed for selectively controlling a pressure of intake air apart from rotation speed of a turbocharger. U.S. Pat. No. 8,302,402 to Boley et al. is entitled air induction system with recirculation loop. Boley et al. propose an air induction system where a compressor is operable to compress air directed into an engine. A throttle valve is disposed between the compressor and the engine, and a recirculation valve is disposed between the compressor and the throttle valve. The recirculation valve is apparently actuated in response to a pressure differential between air upstream of the throttle valve and air downstream of the throttle valve.

### SUMMARY

In one aspect, controlling intake pressure in a gaseous fuel internal combustion engine includes calculating a control term in an intake pressure control loop, based on a difference between measured pressure and desired pressure in an intake conduit of the internal combustion engine. The controlling of intake pressure further includes adjusting an electrically actuated throttle valve within the intake conduit responsive to the control term in a first control loop cycle, and adjusting an electrically actuated second valve responsive to the control term in a second control loop cycle. The second valve is within a return conduit extending from a location downstream a compressor within the intake conduit to another location upstream the compressor. The controlling of intake pressure further includes changing a pressure of gaseous fuel and air within the intake conduit via the adjustments of the throttle valve and the second valve, so as to reduce the difference between measured pressure and desired pressure.

In another aspect, a gaseous fuel internal combustion engine includes an engine housing having a plurality of cylinders formed therein, and an air and fuel delivery system. The air and fuel delivery system includes an intake conduit coupled with the engine housing so as to supply intake air and gaseous fuel to the plurality of cylinders, a compressor positioned at least partially within the intake conduit, and a return conduit fluidly connected to the intake conduit at a location downstream the compressor and at another location upstream the compressor. The air and fuel delivery system further includes an electrically actuated throttle valve within the intake conduit, an electrically actuated second valve within the return conduit, and an electronic control unit in control communication with actuators of each of the throttle valve and the second valve. The electronic control unit is further configured to calculate a control term based on a difference between measured pressure and desired pressure in the intake conduit, and to responsively output commands to each of the actuators so as to sequentially change a position of the throttle valve and a position of the second valve to reduce the difference between measured pressure and desired pressure.

In still another aspect, an intake pressure control system for a gaseous fuel internal combustion engine includes a first valve actuator configured to couple with a throttle valve in an intake conduit of the internal combustion engine, and a second valve actuator configured to couple with a second valve in a return conduit extending from a first location downstream a compressor within the intake conduit to a second location upstream the compressor. The system further includes an electronic control unit in control communication with the first and second valve actuators. The electronic control unit is configured via executing an intake pressure control loop to calculate a control term based on a difference between measured intake pressure and desired intake pressure in the intake conduit. The electronic control unit is further configured to output commands based on the control term to the first and second valve actuators in each of a first cycle and a second cycle of the intake pressure control loop, and to sequentially adjust the throttle valve and the second valve via the commands so as to reduce the difference between measured pressure and desired pressure.

### BRIEF DESCRIPTION OF THE DRAWINGS

FIG. 1 is a schematic view of an engine system, according to one embodiment;

FIG. 2 is a block diagram of a control strategy, according to one embodiment; and

FIG. 3 is a flowchart illustrating an example control process including control logic, according to one embodiment.

### DETAILED DESCRIPTION

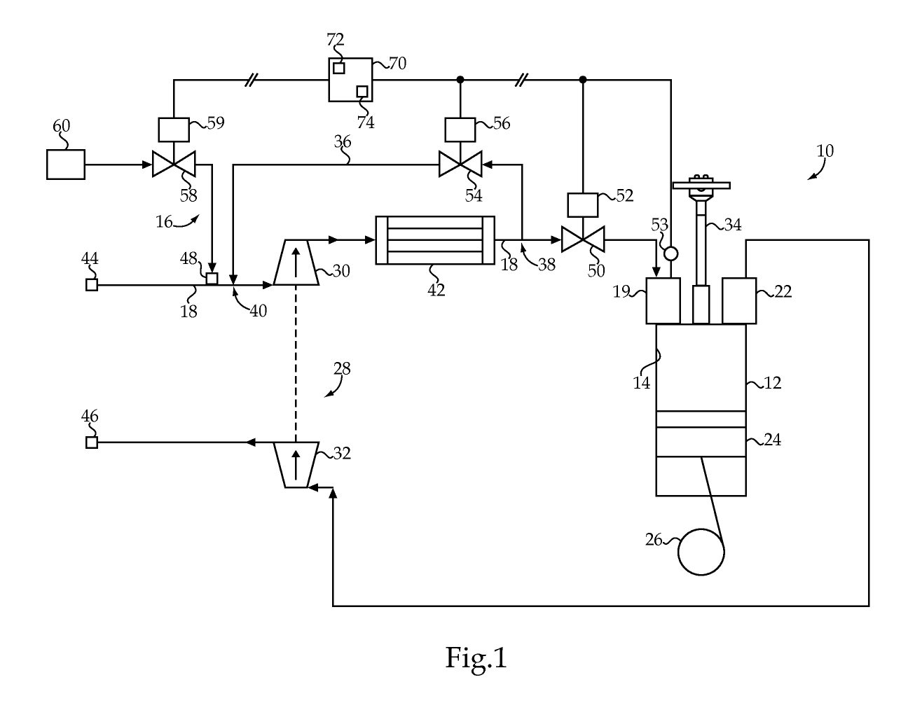

Referring to FIG. 1, there is shown a gaseous fuel internal combustion engine 10 according to one embodiment, and including an engine housing 12 having a plurality of cylinders 14 formed therein, one of which is shown. A piston 24 is movable within cylinder 14 between a top dead center position and a bottom dead center position in a conventional manner to induce rotation of a crankshaft 26. It will be appreciated that additional cylinders, commonly six, eight, twelve or more cylinders are hidden from view in the FIG. 1 illustration, each having a piston reciprocable therein to contribute to the rotation of crankshaft 26. An intake manifold 19 is coupled with housing 12 and supplies intake air as well as gaseous fuel to each of the cylinders by way of appropriate intake valves (not shown). An exhaust manifold 22 is also coupled with housing 12 and receives exhaust gases from cylinder 14 and the other cylinders in a generally conventional manner, by way of exhaust valves (not shown).

An air and fuel delivery system 16 includes an intake conduit 18 coupled with engine housing 12 so as to supply intake air and gaseous fuel to cylinders 14 by way of intake manifold 19, which can be understood as forming a part of intake conduit 18. System 16 further includes a compressor 30 positioned at least partially within intake conduit 18, and typically part of a turbocharger 28 having a turbine 32 positioned within an exhaust conduit 47 extending from exhaust manifold 22 to an exhaust outlet 46. In a practical implementation strategy, an air inlet 44, typically including an air filter, supplies intake air to intake conduit 18, whereby the intake air is conveyed to and past compressor 30, through an aftercooler 42, into intake manifold 19 and into the engine cylinders 14. System 16 further includes a return conduit 36 fluidly connected to intake conduit 18 at a first location 38 downstream compressor 30 and at another location 40 upstream compressor 30. System 16 may further include a gaseous fuel inlet 48 connecting to intake conduit 18 at a location upstream compressor 30, and in the illustrated embodiment also upstream location 40 where return conduit 36 connects with intake conduit 18. System 16 may also include a gaseous fuel metering valve 58 having an electrical actuator 59, and receiving gaseous fuel from gaseous fuel supply and pressure control mechanisms 60.

Mechanisms 60 may include a liquefied fuel tank, a cryogenic pump, and such other elements as are commonly used and well known in the art. An ignition mechanism 34 is coupled with engine housing 12, and may include a spark ignition mechanism such as a spark plug extending into cylinder 14, but in other embodiments might include a pre-combustion chamber connected to mechanisms 60 and configured to spark or compression ignite a pilot fuel charge which is then used to ignite a main fuel charge in cylinder 14. As alluded to above, certain internal combustion engines, and notably gaseous fuel engines, can benefit from relatively precise control of intake pressure. As will be further apparent from the following description, engine 10 is uniquely configured to control intake pressure in a manner having various advantages over the state of the art.

To this end, system 16 may further include an electrically actuated throttle valve 50 within intake conduit 18, and having an electrical actuator 52. System 16 may also include an electrically actuated second valve 54 having an electrical actuator 56, within return conduit 36. An electronic control unit 70 is in control communication with actuator 52 and actuator 56. Electronic control unit 70 may also be in control communication with actuator 59 of fuel metering valve 58. Actuators 52 and 56, together with electronic control unit 70, may be understood to comprise an intake pressure control system. Electronic control unit 70 may include a microprocessor 72 and a computer readable medium 74 storing code executable by processor 72, for various purposes but notably for controlling intake pressure in engine 10 via varying positions of valve 50 and valve 54. Electronic control unit 70 may be configured in particular to execute code on computer readable memory 74 in an intake pressure control loop. Execution of the intake pressure control loop may include calculating a control term based on a difference between measured pressure and desired pressure in intake conduit 18, and responsively outputting commands to each of actuators 52 and 56 so as to sequentially change a position of throttle valve 50 and a position of second valve 54 to reduce the difference between measured pressure and desired pressure.

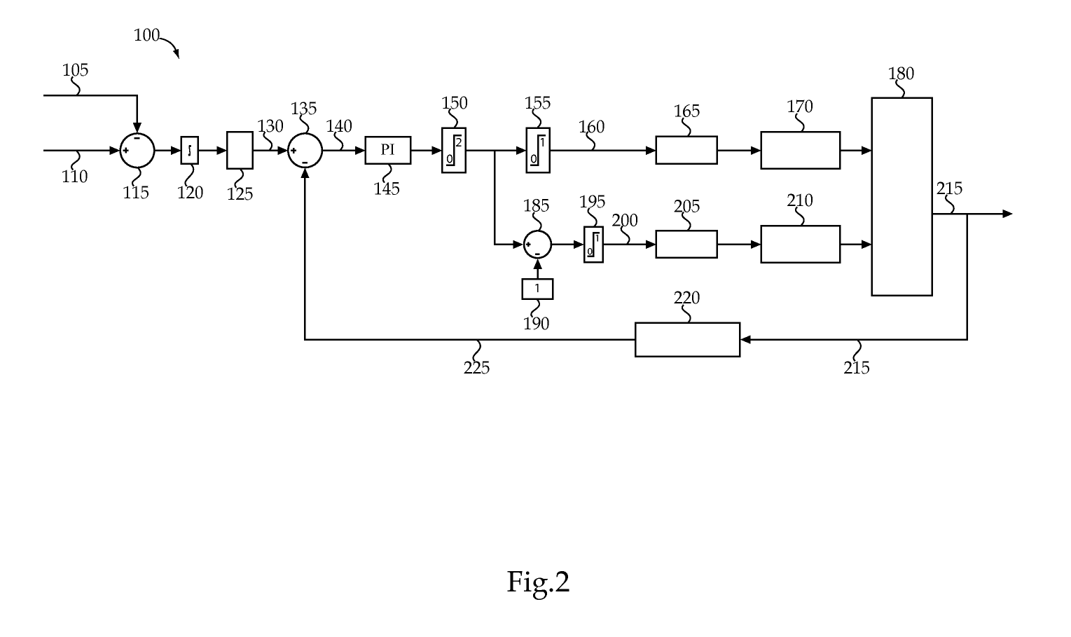

Referring now also to FIG. 2, there is shown a block diagram 100 of a control strategy including an intake pressure control loop according to the present disclosure. In diagram 100, a desired fuel charge flow input 105 and an estimated charge flow input 110 are processed at a summer block 115. Processing at block 115 may be understood as a calculation determining a fuel charge flow error. The output from block 115 is processed at an integration block 120, and further at a processing block 125 according to the ideal gas equation to generate an output 130 which is an estimated manifold pressure (IMAP), in other words a desired IMAP needed, based upon a desired lean ratio of air to gaseous fuel. Input 110 may be based upon calculations of mass flow to the engine through inlet valves according to known techniques. Input 105 may be based upon engine load and engine speed requests or requirements, again in a known manner. The desired pressure 130 and a sensed pressure 225 may be processed at another summer block 135 to generate a pressure error output 140. The pressure error output 140 is processed via a proportional controller, such as a PI controller 145, so as to calculate a control term 150.

Control term 150, calculated responsive to the intake pressure error 140, may have a value in a finite range, such as from 0 to 2. In a practical implementation strategy, one of actuators 52 and 56 may be configured to respond to a control term value in a range from about 0 to about 1, whereas the other of actuators 52 and 56 may be configured to respond to a control term having a value in a range from about 1 to about 2. In a practical implementation strategy, control commands for throttle valve actuator 52 and for second valve actuator 56 may be determined in every control loop cycle, and output to actuators 52 and 56 in every control loop cycle. Control term 150 is shown having a value from 0 to 1 at block 155, where a throttle area command 160 is determined. The throttle area command 160 may be processed according to an area-to-position-linearization map at block 165, and then a control signal output to throttle actuator 52, shown as block 170. If the value of the control term is greater than 1, then actuator 52 will not be adjusted.

At block 185, a shifting term 190, which may have a value of 1, is subtracted from the control term. Electronic control unit 70 is thus understood as being configured to determine a shifted value based on the control term. Accordingly, at block 185 if the control term has a value from 0 to 1 then a zero or negative value will result, and actuator 56 will not be adjusted. If, however, the control term has a value from 1 to 2, subtracting 1 renders a positive value from 0 to 1 at block 195. A second valve area command 200 is processed at block 205 according to another area-to-position linearization map. Block 210 represents actuator 56. Block 180 is a throttle valve and second valve to IMAP transfer function, and output 215 is IMAP. IMAP 215 is sensed via sensor and filter block 220, generating sensed IMAP 225. As noted above, executing an intake pressure control loop can include calculating a pressure error. Engine 10, and more particularly system 16, may also include a sensor 53 which may be configured to monitor a parameter indicative of a pressure of a mixture of gaseous fuel and air within intake conduit 18. Sensor 53 may be a conventional intake manifold pressure sensor.

From the foregoing description it will be understood that both of valves 50 and 54 are adjusted responsive to a control term calculated in the intake pressure control loop. Depending upon the value of the control term, throttle valve 50 may be adjusted responsive to the control term in a first control loop cycle, and second valve 56 may be adjusted responsive to the control term in a second control loop cycle, which may include a next subsequent cycle. The control term may have a first raw value in the first cycle and a second raw value in the second cycle. Changing positions of valves 50 and 54 will thus depend upon the value of the calculated control term. While some degree of overlap might certainly exist, in general terms, where engine load or speed, and thus fuel change amount, is to be increased throttle valve 50 will be opened to provide increased air and fuel and thus increased air and fuel pressure in manifold 19 up until a point at which throttle valve 50 is wide open. Where throttle valve 50 is wide open, it has reached a limit of its authority over intake pressure. At or just before the point at which throttle valve 50 is wide open, second valve 54 may begin to be moved from a wide open position toward a closed position, further increasing intake pressure and thus fuel and air pressure in manifold 19. Where engine speed and engine load are to be reduced, and thus a gaseous fuel charge amount reduced, valve 54 will first be moved toward its wide open position, and valve 50 then moved towards a closed position at or close to the point at which the limit of authority of valve 54 is reached. In this general manner, it can be seen that valve 54 acts much like an extension of throttle valve 50. This strategy differs from known systems where a recirculation or return valve, sometimes called a compressor bypass valve, was used to control compressor outlet pressure upstream of a throttle valve, typically to avoid running up against hardware limitations. In these earlier strategies the throttle valve typically had sole control authority over intake pressure, resulting in common situations where a throttle valve and a compressor bypass valve worked in opposition or “fought” each other. The present disclosure overcomes these disadvantages.

### INDUSTRIAL APPLICABILITY

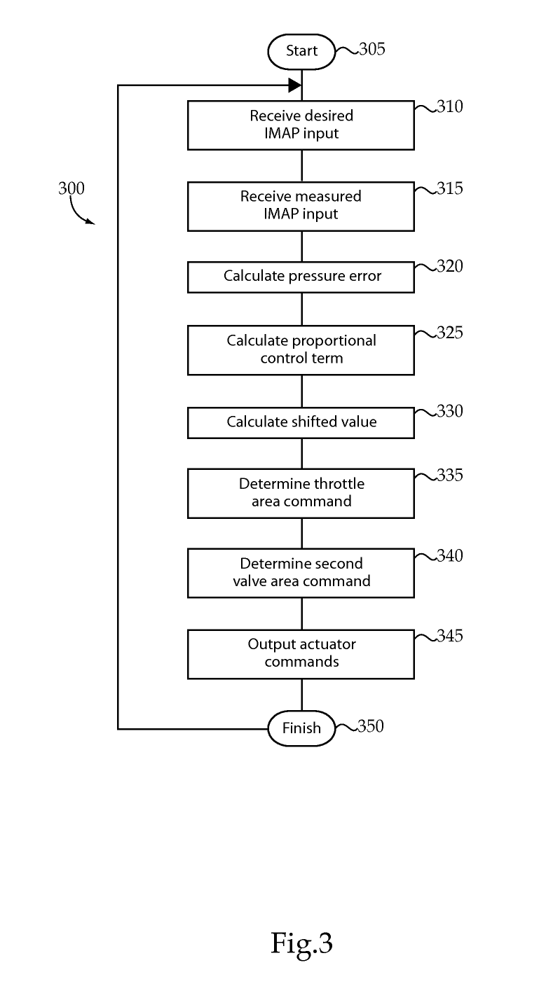

Referring to the drawings generally, but in particular now to FIG. 3, there is shown a flowchart 300 illustrating an example control process including control logic executed by electronic control unit 70, according to one embodiment. The process of flowchart 300 may commence at a start or initialize step 305, and then proceed to step 310 to receive desired IMAP input. From step 310, the process may proceed to step 315 to receive measured IMAP input. From step 315 the process may proceed to step 320 to calculate the pressure error, for instance based upon a difference between the measured pressure and desired pressure. As discussed above, the desired pressure may be based on a desired intake pressure corresponding to a desired lean ratio of air to gaseous fuel in engine 10. Lean means less than a stoichiometric amount of gaseous fuel for an amount of oxygen is present, having in many instances desirable emissions control properties well known to those skilled in the art. From step 320, the process may proceed to step 325 to calculate the control term, including a proportional integral control term, as discussed herein.

From step 325 the process may proceed to step 330 to calculate a shifted value. As discussed above in connection with FIG. 2, the shifted value may include a raw value of the control term shifted by subtracting a number from that raw value, such as subtracting 1. From step 330 the process may proceed to step 335 to determine the throttle area command. As discussed above, the throttle area command may command an open gas passage area of the throttle, which command can be processed according to an area to position linearization map at control block 165, to produce a control signal or actuator command to throttle valve actuator 52. If the control term is outside of a range to which throttle valve 50 is designed to respond, then nothing happens in response to the command. If, instead, the value of the control term is such that throttle valve 50 is capable of responding then a position of throttle valve 50 will be adjusted. From step 335, or prior to or in parallel with step 335, the process may proceed to step 340 to determine second valve area command. Generally analogous to valve 50, if the value of the control term is outside the range to which valve 54 is designed to respond, nothing happens. If the value of the control term is in a range to which valve 54 responds, then a position of valve 54 will be adjusted. It will be recalled that control commands to each of actuators 52 and 56 are calculated each control loop cycle. In the case of actuator 52, adjustments are made responsive to the raw value of the control term whereas in the case of actuator 56, adjustments are made responsive to a shifted value of the control term. Adjusting either of valves 50 and 54 results in changing a pressure of gaseous fuel and air within intake conduit 18 so as to reduce the difference between measured pressure and desired pressure. From step 340, the process may proceed to step 345 to output actuator commands, and may then loop back to repeat, or FINISH at step 350.

It will be apparent from the foregoing description that handing off of authority over intake pressure occurs at limits of authority, in other words capacity to affect, of valves 50 and 54 over intake pressure. The present system thus enables seamless transitioning between throttle-based control and second valve-based control during load changes. Electronic control unit 70 may continuously cycle through the intake pressure control loop, and adjustments to intake pressure will naturally transition between the throttle and second values. This differs from earlier strategies where throttle and recirculation valves had different functions controlled to different parameters. In many instances, the present strategy can be expected to be easier to customize and/or calibrate and less sensitive to hardware limitations given the removal of the need to optimize to a sweet spot where the throttle and second valve do not fight one another. It will also be unnecessary in many instances to employ dedicated compressor surge control. In certain known systems, a recirculation valve is used to manage compressor surge. Due to the manner in which the two valves are sequentially operated according to the present disclosure, a maximum compressor surge margin will typically exist, eliminating the need for a dedicated surge controller and also eliminating the need for a boost pressure sensor.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A method of controlling intake pressure in a gaseous fuel internal combustion engine comprising the steps of:
calculating a control term in an intake pressure control loop, based on a difference between measured pressure and desired pressure in an intake conduit of the internal combustion engine;
adjusting an electrically actuated throttle valve within the intake conduit responsive to the control term in a first control loop cycle;
adjusting an electrically actuated second valve responsive to the control term in a second control loop cycle, where the second valve is within a return conduit extending from a location downstream a compressor within the intake conduit to another location upstream the compressor; and
changing a pressure of gaseous fuel and air within the intake conduit via the adjustments of the throttle valve and the second valve, so as to reduce the difference between measured pressure and desired pressure.

2. The method of claim 1 wherein the control term has a first raw value in the first control loop cycle and a second raw value in the second control loop cycle.

3. The method of claim 2 further comprising a step of determining a control command for a throttle valve actuator and a control command for a second valve actuator in each of the first and second control loop cycles.

4. The method of claim 3 wherein the step of determining further includes determining the control command for the throttle valve actuator based on the first raw value, and shifting the second raw value so as to determine the control command for the second valve actuator.

5. The method of claim 2 further comprising a step of transitioning intake pressure control between the throttle valve and the second valve at limits of authority of each of the throttle valve and the second valve.

6. The method of claim 1 further comprising a step of calculating an intake pressure error, and wherein the step of calculating a control term includes calculating a proportional integral control term responsive to the intake pressure error.

7. The method of claim 6 wherein the step of calculating an intake pressure error further includes calculating the intake pressure error based on a desired intake pressure corresponding to a desired lean ratio of air to gaseous fuel in the internal combustion engine.

8. A gaseous fuel internal combustion engine comprising:
an engine housing having a plurality of cylinders formed therein;
an air and fuel delivery system including an intake conduit coupled with the engine housing so as to supply intake air and gaseous fuel to the plurality of cylinders, a compressor positioned at least partially within the intake conduit, and a return conduit fluidly connected to the intake conduit at a location downstream the compressor and at another location upstream the compressor;
the air and fuel delivery system further including an electrically actuated throttle valve within the intake conduit, an electrically actuated second valve within the return conduit, and an electronic control unit in control communication with actuators of each of the throttle valve and the second valve; and
the electronic control unit being configured to calculate a control term based on a difference between measured pressure and desired pressure in the intake conduit, and to responsively output commands to each of the actuators so as to sequentially change a position of the throttle valve and the second valve to reduce the difference between measured pressure and desired pressure.

9. The engine of claim 8 wherein the electronic control unit is further configured to output the commands to each of the actuators in sequential intake pressure control loop cycles.

10. The engine of claim 8 wherein the air and fuel delivery system further includes a gaseous fuel metering mechanism coupled with the intake conduit at a location upstream the compressor.

11. The engine of claim 10 wherein the intake conduit includes an intake manifold, and further comprising a sensor configured to monitor a parameter indicative of a pressure of a mixture of gaseous fuel and air within the intake manifold.

12. The engine of claim 11 wherein the electronic control unit is further configured to calculate an intake pressure error responsive to data from the sensor, and to calculate the control term responsive to the intake pressure error.

13. The engine of claim 12 wherein the control term includes a proportional control term having a value in a finite range, and the electronic control unit is further configured to determine a throttle area command and a second valve area command responsive to a value of the control term.

14. An intake pressure control system for a gaseous fuel internal combustion engine comprising:
a first valve actuator configured to couple with a throttle valve in an intake conduit of the internal combustion engine;
a second valve actuator configured to couple with a second valve in a return conduit extending from a first location downstream a compressor within the intake conduit to a second location upstream the compressor; and
an electronic control unit in control communication with the first and second valve actuators;
the electronic control unit being configured via executing an intake pressure control loop to calculate a control term based on a difference between measured intake pressure and desired intake pressure in the intake conduit; and
the electronic control unit being further configured to output commands based on the control term to the first and second valve actuators in each of a first cycle and a second cycle of the intake pressure control loop, and to sequentially adjust the throttle valve and the second valve via the commands so as to reduce the difference between measured pressure and desired pressure.

15. The system of claim 14 further comprising a sensor configured to monitor a parameter indicative of pressure in an intake manifold comprising a part of the intake conduit, and wherein the electronic control unit is further configured to calculate an intake pressure error responsive to data from the sensor, and to calculate the control term responsive to the intake pressure error.

16. The system of claim 15 wherein the electronic control unit is further configured to determine a shifted value of the control term, and to determine commands for the second valve actuator responsive to the shifted value of the control term.

17. The engine of claim 14 wherein the control term includes a proportional integral control term having a value in a finite range, and the electronic control unit is further configured via executing the intake pressure control loop to determine a throttle area command and a second valve area command responsive to a value of the proportional integral control term.
